(19) United States
(12) Patent Application Publication
(10) Pub. No.: US 2026/0252731 A1
(43) Pub. Date: Aug. 27, 2026

(54) SAFELY RENAMING STRINGS IN BINARY METADATA SECTIONS FOR CODE PROTECTION

(71) Applicant: Digital.ai Software, Inc., Raleigh, NC (US)

(72) Inventors: Jacob Benjamin Wiens, Oak Forest, IL (US); Amir Benjamin Amitay, Yesod HaMa’ala (IL); Jason Christopher Holajter, West Lafayette, IN (US); Cole Tyler Herzog, West Lafayette, IN (US)

(21) Appl. No.: 19/061,772

(22) Filed: Feb. 24, 2025

(51) Int. Cl. G06F 21/62

(52) U.S. Cl. CPC G06F 21/6254

(57) ABSTRACT

A code obfuscation tool has been created to safely rename strings within metadata sections of an executable file or binary to obscure program functionality and structure that may be revealed by class metadata in the binary. The code obfuscation tool parses metadata sections of the binary that have references to metadata that can be potentially renamed safely and locates the corresponding strings. The code obfuscation tool identifies from predetermined metadata sections metadata that is unsafe to rename. The code obfuscation tool evaluates each string that is a candidate for renaming against heuristics-based renaming rules and the determined unsafe strings to identify strings that are safe to rename. The code obfuscation tool generates a new name for each string determined as safe to rename based on renaming constraints. The code obfuscation tool creates a mapping structure that tracks renaming of strings and uses the mapping structure for consistent renaming of string.

### BACKGROUND

The disclosure generally relates to renaming metadata in a binary file (e.g., CPC subclass G06F 21/14).

Code obfuscation is a technique to hide important data and functionality from malicious actors and to protect intellectual property. Types of code obfuscation include string encryption, control flow obfuscation, and class and function renaming. String encryption encrypts strings, such as function names and class names. Control flow obfuscation alters the order of program execution statements or adds extra flow control statements to code to make it difficult to determine execution flow. Class and function renaming renames functions and class names to obscure the purpose of those classes or functions.

### BRIEF DESCRIPTION OF THE DRAWINGS

Embodiments of the disclosure may be better understood by referencing the accompanying drawings.

FIG. 1 is a diagram of a binary being obfuscated by determining and renaming strings safely and consistently throughout the binary based on heuristics-based rules.

FIG. 2 is a flowchart of example operations for safely renaming class names in an executable file based on heuristics-based rules to protect program code.

FIG. 3 is a flowchart of example operations for evaluating a string against renaming rules and consistently renaming strings that are determined as safe to rename.

FIG. 4 is a flowchart of example operations for updating a renaming tracker with a new name and consistently renaming the original string the new name corresponds to.

FIG. 5 depicts an example computer system with a code obfuscation tool.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

Runtime system or runtime refers to the software that supports or facilitates execution of a program according to an execution model of a programming language. A runtime system supports or facilitates execution of a program by performing tasks or functions that are not specified in the program but are performed to allow program execution. In the case of the Java® programming language, the runtime system is JRE (Java Runtime Environment). In the case of the Swift® programming language, the runtime system is referred to as Swift runtime. Some compilers will insert the runtime system instructions or metadata into an executable image or binary. It is possible that two or more programming languages can share the same runtime (e.g., Swift and Objective-C® programming languages), which is possible due to the runtime having an interface which handles method dispatching and object model compatibility.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Introduction

Penetration tests on applications or program code identify visible class names and function names as vulnerabilities because visible names reduce the challenge of decompiling an executable and studying the decompiled code for exploitable vulnerabilities. Compilers for languages such as Swift or Objective-C generate binaries with metadata which are used by runtime systems to instantiate classes. These binaries reveal class names and structures which can inform malicious actors how the underlying code is organized and how it functions.

While class and function renaming has been used to obscure source code, renaming in binaries can create unexpected problems that interfere with proper execution. For instance, renaming strings in binary run with a runtime system that uses dynamic dispatching or runtime polymorphism can introduce instability in execution because a renamed class cannot be found.

### Overview

A code obfuscation tool has been created to safely rename strings within metadata sections of an executable file or binary to obscure program functionality and structure that may be revealed by names in the metadata of the binary, such as class names and class member names. The code obfuscation tool parses metadata sections of the binary that have names of artifacts (e.g., objects or object elements) or references to names. For metadata sections to be restricted from renaming, the code obfuscation tool parses the section to determine which artifact names are unsafe to rename if they occur elsewhere. For other metadata sections, the code obfuscation tool evaluates each name/string that is a candidate for renaming against heuristics-based renaming rules to identify strings that are safe to rename. Based on determining which strings are safe to rename, the code obfuscation tool generates a new name for each “safe” string based on renaming constraints and consistently renames the safe strings. The resulting obscured binary protects the executable file by reducing the vulnerabilities arising from informative names.

### Example Illustrations

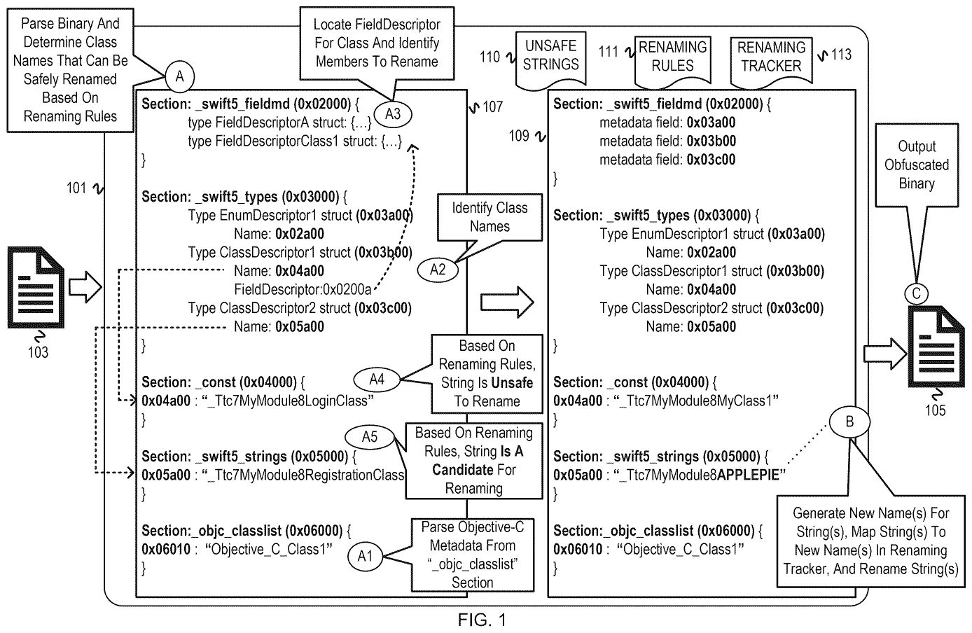

FIG. 1 is a diagram of a code obfuscation tool obscuring a binary with intelligent string renaming based on heuristics-based rules. FIG. 1 depicts a code obfuscation tool 101 which receives a binary 103 and safely renames strings therein to generate an obfuscated binary 105. FIG. 1 depicts the heuristics-based rules as renaming rules 111, which are rules established through experiments and/or observations to determine when string renaming in binary metadata interferes and/or does not interfere with proper execution of the binary 103. FIG. 1 depicts a data structure 110 labeled “Unsafe Strings” which represents a data structure that indicates strings in metadata sections of the binary 103 that are to be restricted from renaming. The code obfuscation tool 101 can utilize the data structure 110 when evaluating the strings to avoid renaming strings that may be safe to rename according to the renaming rules 111 but occur in a metadata section that is restricted from renaming because of possible introduction of instability. FIG. 1 depicts a renaming tracker 113 which stores references to class names that have been renamed and their corresponding assigned new names. The examples below are described using Swift and Objective-C naming conventions.

FIG. 1 depicts content 107 of the binary 103 to illustrate some metadata sections of the binary 103. The content 107 depicted in FIG. 1 are depicted in format chosen for the purposes of explaining the disclosed processes to obscure strings in the binary 103. The metadata sections in the content 107 are labeled by their section names and their file offsets (i.e., the size in bytes the sections are from the beginning of the binary in hexadecimal format). The file offsets are chosen for the sake of simplicity and may not represent actual file offset values as they would appear in a binary. The metadata sections in the content 107 are:
“_swift5_fieldmd” (0x02000),
“_swift5_types (0x03000)”,
“_const” (0x04000),
“_swift5_strings” (0x05000),
and “_objc_classlist” (0x06000).

Each metadata section can store different information. For example, the metadata section “_swift5_types” stores type descriptors which hold references to metadata associated with a Swift data type (e.g., Class, Enums, Structure). Type descriptors which correspond to Class types store metadata about the class. In this example, the type descriptors include a Name field which indicates a reference or address of a class name.

For example, the metadata section “_swift5_types” has the type descriptor “EnumDescriptor1”, which has a “Name” field with the reference: “0x02a00”. Like the offset values of the metadata sections, the references in this example are addresses relative to the binary 103. Therefore, the string which is the name of the EnumDescriptor1 is stored at the relative address “0x02a00”. The other metadata sections in the binary 103 are: “_const”, “_swift5_strings”, and “_objc_classlist”. These metadata sections are examples of metadata sections which store strings. The strings depicted in FIG. 1 are class names, but a metadata section can include names of other types of artifacts (e.g., function names, structure names, variable names, etc.).

The metadata sections and the data in each section depicted in FIG. 1 are only a subset of the types of metadata sections and strings that can appear in a binary. Additional metadata sections can appear in a binary, and each section can have multiple fields with additional metadata.

FIG. 1 is annotated with letters and numbers A, A1-A5, B, and C representing stages of operations, each stage corresponding to one or more operations. Stage A represents a general stage of operations while stages A1-A5 represent specific example stages of Stage A. Although these stages are ordered for this example, the stages illustrate one example to aid in understanding this disclosure and should not be used to limit the claims. Subject matter falling within the scope of the claims can vary from what is illustrated.

At stage A, the code obfuscation tool 101 parses the binary 103 and determines class names that can be renamed safely based on the renaming rules 111. The code obfuscation tool 101 parses the binary 103 based on known patterns and/or regular expressions corresponding to metadata sections to locate the metadata sections within the binary 103. To parse the binary 103, the code obfuscation tool 101 can utilize a parser (not depicted). The parser can be configured based on the language(s) in the binary 103 to detect metadata sections within the binary 103. The code obfuscation tool 101 parses the metadata sections to locate metadata sections with strings that are not safe to rename and strings that can be safely renamed.

At stage A1, the code obfuscation tool 101 parses the “_objc_classlist” metadata section to identify strings unsafe to rename and indicate those in the unsafe strings data structure 110. While parsing the binary 103, the parser detects the metadata section “_objc_classlist” as a metadata section that stores Objective-C metadata. The parser can be configured with a list of metadata sections which store metadata that is unsafe to rename, which in this example is “_objc_classlist”. Each string in the “_objc_classlist” is added to the data structure 110 to track strings that are unsafe to rename.

At stage A2, the code obfuscation tool 101 parses the metadata section “_swift5_types” and identifies references corresponding to class names. The “_swift5_types” section is an example of a metadata section that includes metadata with strings or references to strings for renaming, such as class names. FIG. 1 depicts the “_swift5_types” section with the class descriptors “ClassDescriptor1” and “ClassDescriptor2”. Each class descriptor has a “Name” field which corresponds to the name of the class described by the type descriptor. The “Name” fields for “ClassDescriptor1” and “ClassDescriptor2” store the references “0x04a00” and “0x05a00” respectively. Based on the references, the code obfuscation tool 101 locates the string “_Ttc7MyModule8LoginClass” corresponding to the reference “0x04a00” in the “const” metadata section, and the string “_Ttc7MyModule8RegistrationClass” corresponding to the references “0x05a00” in the “_swift5_strings” metadata section.

At stage A3, the code obfuscation tool 101 parses the metadata section “_swift5_fielmd” and locates names of class members for ClassDescriptor1 based on the “_swift5_fielmd” metadata. The “_swift5_fieldmd” section is another example of a metadata section that includes metadata relevant to renaming, such as names of members or fields of classes. The dashed arrow in FIG. 1 between the “_swift5_types” section and the “swift5_fieldmd” section illustrates the parser locating the FieldDescriptor for the class ClassDescriptor1.

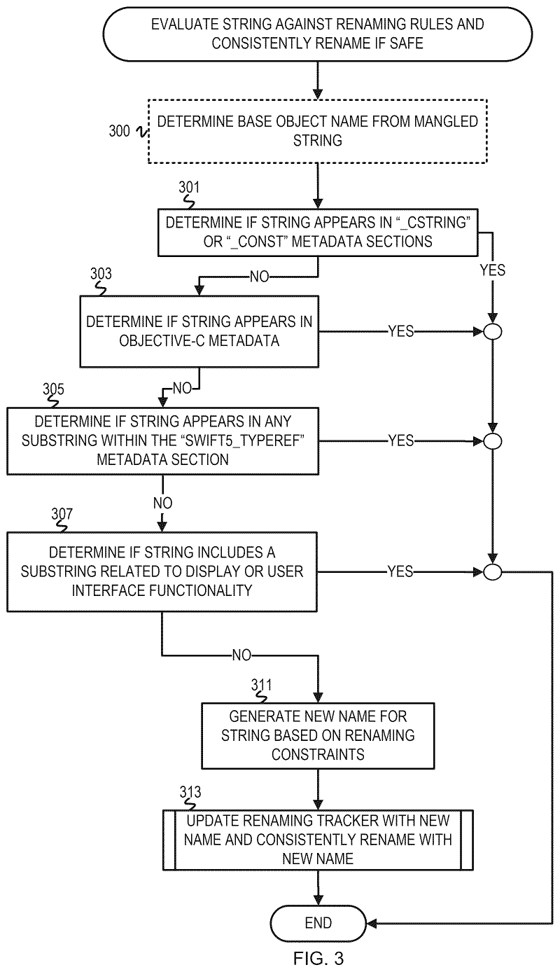

At stage A4, the code obfuscation tool 101 determines the string “_Ttc7MyModule8LoginClass” is unsafe to rename based on the renaming rules 111. This indicates that there is a renaming rule that indicates the string “_Ttc7MyModule8LoginClass” in unsafe to rename. The code obfuscation tool 101 evaluates the string against the renaming rules 111 and determines if any rules apply to the string “_Ttc7MyModule8LoginClass”. As part of evaluating the string, the code obfuscation tool 101 can utilize the unsafe strings in the data structure 110 to assist in the determination of whether the string is safe to rename. FIG. 3 goes into further detail on how strings are evaluated against the heuristics-based rules.

At stage A5, the code obfuscation tool 101 determines the string “_Ttc7MyModule8RegistrationClass” is a candidate for renaming based on the renaming rules 111. This indicates that there is not a renaming rule that specifies the string “_Ttc7MyModule8RegistrationClass” is unsafe to rename. In this example, the string “_Ttc7MyModule8RegistrationClass” is an example of a class name which has been mangled. This means the base class name which is added to the renaming tracker is embedded in the mangled name. Since the mangled class name is determined as a candidate for renaming, the base name is determined from the mangled name and added to the renaming tracker 113. The base name can be extracted from a mangled name by using a string library in the language the code obfuscation tool 101 is written, or through the use of a string parser.

At stage B, the code obfuscation tool 101 generates new names for class names which are determined as candidates for renaming and maps the strings to their new names in the renaming tracker 113. For each class name in the renaming tracker 113, the code obfuscation tool 101 generates a new name that meets renaming constraints (not depicted) configured in the code obfuscation tool 101 and maps the new name to the original class name. An example of a renaming constraint is that a new name should be the same or fewer character length than the original class name. The code obfuscation tool 101 then renames strings in the binary that match each class name in the renaming tracker 113 to their assigned new name. FIG. 1 depicts content 109 of the binary 103 after class names in the renaming tracker 113 are renamed. The content 109 depicts the string “_Ttc7MyModule8ApplePie” within the metadata section “swift5_strings” with the new name “APPLEPIE”. Since the string in the “swift5_strings” section as depicted in the content 107 was a mangled class name, only the substring “RegistrationClass” representing the base class name was renamed to the new name “APPLEPIE”.

At stage C, the code obfuscation tool 101 outputs the obfuscated binary 105. The obfuscated binary 105 can then be provided to the owner of the binary. The obfuscated binary if decompiled/deconstructed will expose the renamed class names instead of their original values.

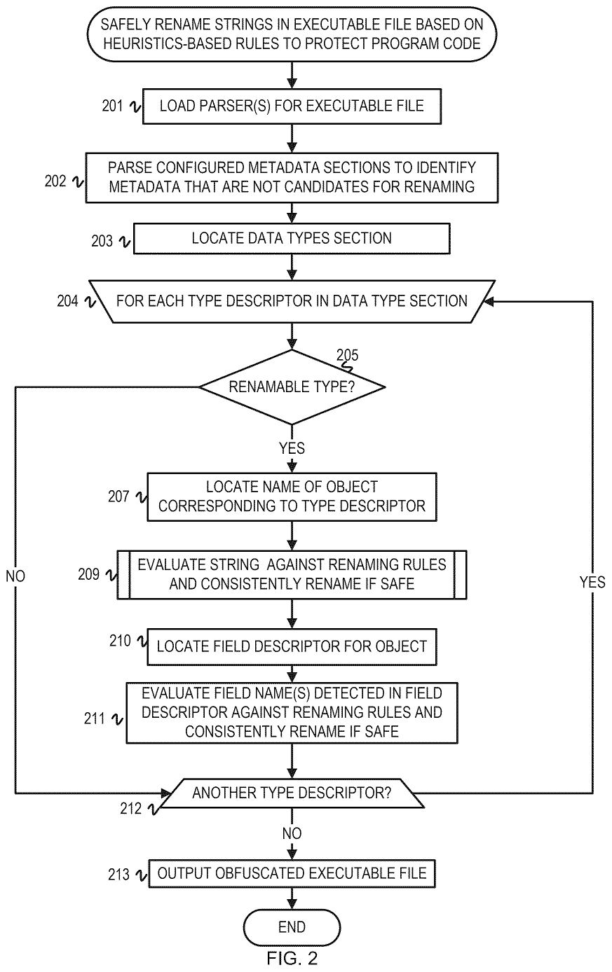

FIGS. 2-4 are flowcharts relating to safely renaming strings in a binary based on heuristics-based rules. The example operations are described with reference to a code obfuscation tool for consistency with FIG. 1 and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary. FIGS. 2-4 describe example operations in which the code obfuscation tool evaluates metadata which corresponds to artifacts, such as objects and elements or fields of objects that can be renamed.

FIG. 2 is a flowchart of example operations for safely renaming strings in metadata of an executable file based on heuristics-based rules. While the preceding example referred to class names as strings examined for renaming, names of other artifacts (e.g., object or elements/fields of an object) in program code can reveal exploitable information, such as function names and variable names.

At block 201, the code obfuscation tool loads a parser(s) for an executable file (previously referred to as a binary). This presumes the code obfuscation tool is program language agnostic and can be used to protect executables generated from various programming languages. For instance, the code obfuscation tool can be invoked on an executable and the invocation can include identifiers of programming languages for the executable file. The code obfuscation tool can then load the appropriate parser, for instance loading a library or identifying an application programming interface (API) to a parser. In some implementations, a code obfuscation tool will be instantiated for particular programming language and be bound or include the appropriate parser. The code obfuscation tool uses the parser to navigate the executable file.

At block 202, the code obfuscation tool identifies metadata that are not candidate for renaming. The code obfuscation tool identifies metadata that is unsafe to rename by parsing the executable file with the loaded parser according to configuration information that identifies unsafe metadata sections by section name. The list of metadata sections is generally based on the programming languages the executable file is based on, and therefore metadata sections which are unsafe for renaming can vary from language to language. A metadata section may be determined as unsafe for renaming if a runtime engine expects certain strings to appear in those sections, and therefore renaming those strings would destabilize the executable file. The loaded parser detects each string in the metadata sections indicated as unsafe for renaming and can add the strings to a tracker of metadata unsafe to rename.

At block 203, the code obfuscation tool locates a data types section. For example, the parser searches for a section title that includes the substring “types”. A data types section is a section which stores metadata about data types or object types (e.g., Classes, Structures, Enums) for a language. Referring to a Swift executable file as an example, the data types section would be “_swift5_types”.

At block 204, the code obfuscation tool parses the data types section to iterate through the type descriptors. For each type descriptor in the section, operational flow continues at block 205.

At block 205, the code obfuscation tool determines if the type descriptor corresponds to a type of object that can be safely renamed. For example, the code obfuscation tool evaluates each type descriptor against a heuristics-based rule that specifies the struct data type cannot be renamed. If the type descriptor indicates type of object that can be renamed, then operational flow continues at block 207. Otherwise, operational flow continues at block 212.

At block 207, the code obfuscation tool locates the name of the object corresponding to the type descriptor. For example, the code obfuscation tool locates a field in the type descriptor which corresponds to the name of the object and identifies the corresponding reference. Similar to the operations described in block 202, the code obfuscation tool uses the parser to locate the corresponding object name in the executable file based on the reference. The code obfuscation tool can determine which metadata section the reference corresponds to by comparing the reference to the metadata section's headers in the executable file. Each section header has metadata about the section's starting address (i.e., file offset) and size. Using this information, the code obfuscation tool can determine which section the reference (and therefore the object name) is stored in. For example, if a section header for the metadata section “_swift5_strings” had the starting address 0x03000 and a size of 0x01000, then a string with the reference “0x031000” would be determined to be inside the “_swift5_strings” section.

At block 209, the code obfuscation tool evaluates the object name against renaming rules and consistently renames the object name if the name is determined as safe for renaming. Renaming rules can be based on factors such as the section a string resides in, whether the string appears as a substring in unsafe metadata sections (i.e., renaming strings in the section would destabilize the binary), or if the string contains certain protected substrings (e.g., “view”). Object names that are determined as safe to rename are added to a renaming tracker which the code obfuscation tool uses to consistently rename the strings in the executable file. FIG. 3 further describes the operations of block 209.

At block 210, the code obfuscation tool locates a field descriptor for the object. Type descriptors corresponding to objects that have elements/fields (e.g., members of a class) include a reference to a field descriptor. A field descriptor includes metadata for one or more fields of an object and that metadata includes names of the one or more fields. The operations of blocks 207 and 210 describe a case in which names of objects or elements/fields of an object are stored as references where the string values are stored separately from the type descriptors. In some cases, an executable file can store names of objects directly within a type descriptor (or similar data structure). Names of elements/fields of an object likewise may be stored directly within a field descriptor.

At block 211, the code obfuscation tool evaluates the field name(s) detected in the field descriptor against renaming rules and consistently renames the field name(s) if safe. Each field name is located using the references in the field records of the field descriptor and is evaluated. This block is similar to the operations described in block 209, however in some cases the code obfuscation tool may implement a different set of renaming rules for field names than object names. At block 212, the code obfuscation tool determines if there is another type descriptor to process. If there is another type descriptor to process, then operational flow returns to block 204. Otherwise, operational flow continues at block 213.

At block 213, the code obfuscation tool outputs the obfuscated executable file. The obfuscated executable file can then be provided to the owner of the executable file for use. The obfuscated executable file when decompiled/deconstructed will not expose exploitable object and element/field names and will be stable since the names were safely renamed by the code obfuscation tool.

FIG. 3 is a flowchart of example operations for evaluating a string against renaming rules and consistently renaming strings that are determined as safe to rename. The string being renamed has already been determined to be the name of a program code artifact that is a candidate for renaming. With the context of the operations presented in FIG. 2, the string has been determined as a candidate for renaming because it is for an object of a data type that is renamable. FIG. 3 applies a few examples of heuristics-based rules informed by observations of the impact of renaming on application stability.

At block 300, the code obfuscation tool determines a base object name from the mangled string. This block of operation is dashed to depict the operation as optional based on whether the string is in a mangled form. Mangled object names are structured strings with substrings that denote specific attributes of the object name. Metadata sections such as “_swift5_strings” can store object names as mangled strings. In this example, the base names for objects are added to the renaming tracker. Therefore, the code obfuscation tool determines the base object name from the mangled class name. To provide an illustrative example, a mangled object name for a class could be “_Ttc7MyModule8RegistrationClass”. The code obfuscation tool can be configured to interpret mangled strings and select out the substring that corresponds to the base object name which in this example is the string “RegistrationClass”.

At block 301, the code obfuscation tool determines whether the string is an object name that is safe to rename based on section residency. The heuristics-based rules will specify metadata sections that are restricted from renaming. For example, the heuristics-based rules may indicate that if a string appears in “_cstring” or “_const” metadata sections. As described in block 207, by locating the string in the executable file, the code obfuscation tool determines the corresponding metadata section the string is stored in. If the string has been located in a metadata section restricted from renaming, then it is unsafe to rename, and operational flow ends since the string cannot be renamed. There can be a distinction in the heuristics-based rules between a string being unsafe to rename anywhere in the executable file if it occurs in a renaming restricted metadata section and instances of a string in a renaming restricted metadata section that cannot be renamed in that section but can in others. For instance, a heuristics-based rule can specify that an object name that occurs in an Objective-C metadata section cannot be safely renamed anywhere within the executable file. In some implementations, the code obfuscation tool preprocesses renaming restricted metadata sections that have object names and builds a list of unsafe strings to rename. The code obfuscation tool can then compare a located string against the unsafe list.

At block 305, the code obfuscation tool determines if the string appears in any substring within the “swift5_typeref” metadata section. The code obfuscation tool can navigate to the “swift5_typeref” metadata section and search for occurrence of the renaming candidate string, including as a substring If a match is found, then the string is an unsafe string and operational flow ends.

At block 307, the code obfuscation tool determines if the string is unsafe based on a substring related to a display or user interface functionality. For example, if the string includes the substring “View” or “UI”, then the code obfuscation tool would determine that the string relates to a display or user interface functionality and cannot be safely renamed. If the code obfuscation tool determines the string is unsafe because it includes a substring related to a display or user interface feature or aspect, operations conclude. Otherwise, operational flow continues at block 309. In this example, a string at this stage has been evaluated by the operations described in blocks 301, 305, and 307 is determined as safe to rename.

At block 311, the code obfuscation tool renames the object corresponding to the string based on renaming constraints. The code obfuscation tool generates a new string based on renaming constraints and replaces the candidate string with the new string to rename the object. An example of how the code obfuscation tool can generate a new string/name is through a pseudo-random name generator. The pseudo-random name generator generates new names based on constraints configured by the code obfuscation tool. An example of a constraint is that the new name should have no relationship to the original class name. For example, if a string was “UserClass”, then the new name should not have any strings or substrings which have a relationship to the string “User”. Another example of a constraint is that a new name should have the same or fewer number of characters as the original class name. The code obfuscation tool verifies that the new name generated was not previously generated for another string in the renaming tracker. If the new name is already in the renaming tracker, or if the new name does not satisfy configured renaming constraints, then the code obfuscation tool will generate a different name and verify the new name meets renaming constraints.

In some implementations, in lieu of a name generation service, the code obfuscation tool can generate a hash of the string. The code obfuscation tool can apply a hashing algorithm to the string to generate a hash sequence as the new name. In this case, each hash sequence based on the original string will be unique and therefore the code obfuscation tool may eschew redundancy checking depending on the likelihood of collisions for the hashing algorithm. Alternatively, the code obfuscation tool can select the new name from a list of pre-determined approved strings. In this case, the selected name is still subject to renaming constraints and determination if there is a duplicate value for the selected name in the renaming tracker.

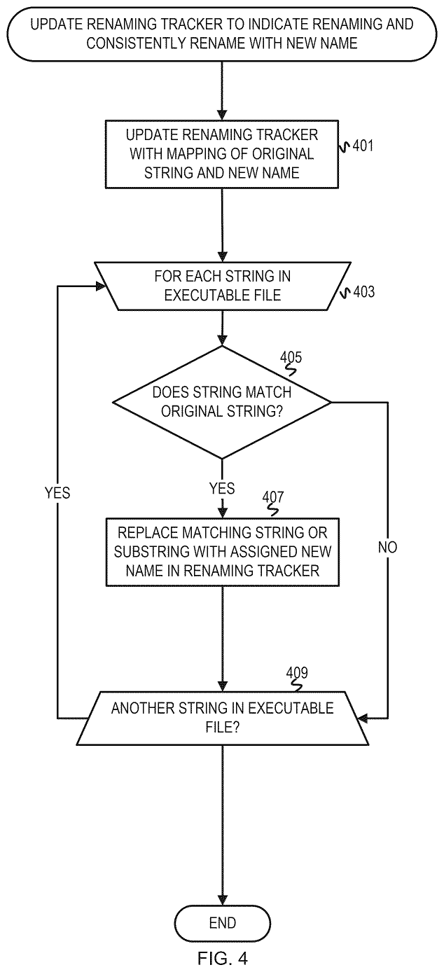

At block 313, the code obfuscation tool updates the renaming tracker to indicate the new name of the corresponding object as represented by the original string and propagates the renaming. This operation is further described in FIG. 4.

FIG. 4 is a flowchart of example operations for updating a renaming tracker with a new name and propagating the renaming. At block 401, the code obfuscation tool updates the renaming tracker with a mapping of the original string and a new name. For instance, the code obfuscation tool adds the mapping as a key-value pair.

At block 403, the code obfuscation tool iterates through each string in unrestricted metadata sections in the executable file. The code obfuscation tool can use the parser to navigate to each metadata section in a list of unrestricted metadata sections or iterate through the metadata sections and then determine whether the section is restricted from renaming strings therein. A string of a current iteration is referred to as a currently selected string.

At block 405, the code obfuscation tool compares the currently selected string to the original string and determines if the currently selected string matches the original string. Matching includes matching the safe string to a substring within the currently selected string. If a match is detected, operational flow continues at block 407. Otherwise, operational flow continues at block 409.

At block 407, the code obfuscation tool replaces the matching string or substring with the assigned new name in the renaming tracker. The code obfuscation tool references the new name in the renaming tracker that corresponds to matching string or substring and replaces it with the new name. An example of a substring that matches an original string is the string “class1_function1”, where “class1” is the original string determined as being safe to rename. The code obfuscation tool in this example replaces the matching portion of the string “class1” with a new name such as “Apple”. Therefore, the string when renamed would be “Apple_function1”. This is an example of a string being a name of a function which is an element/field of an object, in this case a class.

The implementation described in FIG. 4 describes a case in which object names are evaluated and renamed before the names of their members. Therefore elements/fields of an object whose name includes its parent object's name may have already been partially renamed using the method described above. When the code obfuscation tool evaluates a string that has already been partially renamed, the code obfuscation tool can rename the portion of the element/field's name that is unique to the member (e.g., “field1” in the string “class1_field1”). Following the above example, the string “Apple_function1” has been partially renamed, and therefore by renaming the “function1” portion of the string to a string such as “Banana”, the resulting string would be “Apple_Banana”. Alternatively, the code obfuscation tool can skip the renaming of the element/field's name if renaming a subsequent time would destabilize the executable file.

At block 409 the code obfuscation tool determines if there is another string in an unrestricted metadata section to process. The code obfuscation tool will continue to parse the executable file to detect further strings. If the code obfuscation tool does not detect another string, then operations conclude. Otherwise, operational flow returns to block 403.

### Variations

The example operations of FIG. 4 presume a propagation approach that generates a new name for a first detected/located occurrence of a safe string for an artifact and then propagating the renaming. This may be considered a multi-pass approach since the executable would be traversed after each first instance of renaming. Embodiments are not so limited, and may implement a single pass approach, at least with respect to the renaming. In the single-pass approach, the code obfuscation tool would traverse each unrestricted metadata section and use the renaming tracker to determine whether a safe string is a first instance of renaming or a subsequent instance of renaming for rename propagation.

The flowcharts are provided to aid in understanding the illustrations and are not to be used to limit the scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, which employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

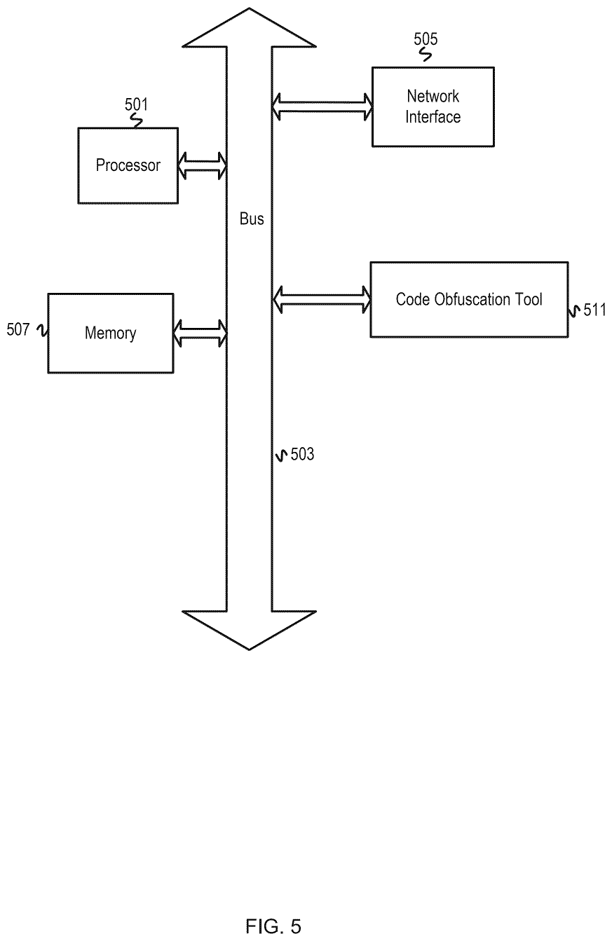

FIG. 5 depicts an example computer system with a code obfuscation tool. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes a code obfuscation tool 511. The code obfuscation tool 511 parses over a binary identifies references that correspond to class names. The code obfuscation tool 511 locates the corresponding string and evaluates the string based on heuristics-based rules to determine if the strings are safe to renamed. For strings determined as safe to be renamed, the code obfuscation tool adds the strings to a renaming tracker. For each string in the renaming tracker, the code obfuscation tool 511 tool generates a new name based on renaming constraints and updates the renaming tracker with the new names. The code obfuscation tool 511 renames strings in the executable file with their assigned name in the renaming tracker and outputs the obscured executable file. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

1. A method comprising:
renaming artifacts in metadata sections of an executable file while preserving execution stability of the executable file, wherein the renaming comprises,
identifying a first subset of the metadata sections restricted from artifact renaming based on a set of one or more heuristics-based rules;
indicating a first set of artifact names within the first subset of metadata sections as unsafe to rename;
determining which artifact names are safe to rename in each of a second subset of the metadata sections based on the set of heuristics-based rules, wherein determining which artifacts are safe to rename comprises,
determining as unsafe to rename an artifact name in the metadata section if in the first set of artifact names as a string or substring; and
evaluating the artifact name detected in the metadata section against the set of heuristics-based rules; and
renaming each artifact name determined to be safe to rename.

2. The method of claim 1, wherein renaming comprises invoking a pseudo-random word generator and renaming based on output of the pseudo-random word generator.

3. The method of claim 1, wherein renaming comprises computing a hash value of an artifact name and renaming with the hash value.

4. The method of claim 1, wherein renaming comprises arbitrarily selecting from a list of strings predefined for use in renaming.

5. The method of claim 1 further comprising parsing the executable file to locate the metadata sections.

6. The method of claim 1 further comprising maintaining a mapping of original artifact names to new artifact names, wherein renaming comprises searching the executable file for subsequent occurrences of an original artifact name and replacing the original artifact name with a mapped new artifact name.

7. The method of claim 1, wherein the set of one or more heuristics-based rules comprises at least one of a rule indicating that an artifact name that matches a substring of an artifact name in the typeref metadata section cannot be safely renamed, a rule indicating that an artifact name that matches any artifact name that corresponds to Objective-C metadata cannot be safely renamed, a rule indicating that an artifact name that is a class name cannot be renamed if the artifact name also occurs in the cstring section, and a rule indicating that the artifact name to be renamed cannot relate to a user interface.

8. The method of claim 1, wherein determining which artifact names are safe to rename comprises determining as unsafe an artifact name for an artifact that is not a class, function, or variable.

9. A non-transitory, machine-readable medium having program code stored thereon, the program code comprising instructions to:
identify a first subset of the metadata sections restricted from artifact renaming based on a set of one or more heuristics-based rules;
indicate a first set of artifact names within the first subset of metadata sections as unsafe to rename;
determine which artifact names are safe to rename in each of a second subset of the metadata sections based on the set of heuristics-based rules, wherein instructions to determine which artifacts are safe to rename comprises instructions to,
determine as unsafe to rename an artifact name in the metadata section if in the first set of artifact names as a string or substring; and
evaluate the artifact name detected in the metadata section against the set of heuristics-based rules; and
rename each artifact name determined to be safe to rename.

10. The non-transitory, machine-readable media of claim 9, wherein the instructions to rename comprise instructions to invoke a pseudo-random word generator and instructions to rename based on output of the pseudo-random word generator.

11. The non-transitory, machine-readable media of claim 9, wherein the instructions to rename comprise instructions to compute a hash value of an artifact name and instructions to rename with the hash value.

12. The non-transitory, machine-readable media of claim 9, wherein the instructions to rename comprise instruction to arbitrarily select from a list of strings predefined for use in renaming.

13. The non-transitory, machine-readable media of claim 9, wherein the program code further comprises instructions to parse the executable file to locate the metadata sections.

14. The non-transitory, machine-readable media of claim 9, wherein the program code further comprises instructions to maintain a mapping of original artifact names to new artifact names, wherein the instructions to rename comprise instructions to search the executable file for subsequent occurrences of an original artifact name and replace the original artifact names with a mapped new artifact name.

15. The non-transitory, machine-readable media of claim 9, wherein the set of one or more heuristics-based rules comprises at least one of a rule indicating that an artifact name that matches a substring of an artifact name in the typeref metadata section cannot be safely renamed, a rule indicating that an artifact name that matches any artifact name that corresponds to Objective-C metadata cannot be safely renamed, a rule indicating that an artifact name that is a class name cannot be renamed if the artifact name also occurs in the cstring section, and a rule indicating that the artifact name to be renamed cannot relate to a user interface.

16. The non-transitory, machine-readable media of claim 9, wherein instructions to determine which artifact names are safe to rename comprise instructions to determine as unsafe an artifact name for an artifact that is not a class, function, or variable.

17. An apparatus comprising:
a processor; and
a machine-readable medium having instructions stored thereon that are executable by the processor to cause the apparatus to,
identify a first subset of the metadata sections restricted from artifact renaming based on a set of one or more heuristics-based rules;
indicate a first set of artifact names within the first subset of metadata sections as unsafe to rename;
determine which artifact names are safe to rename in each of a second subset of the metadata sections based on the set of heuristics-based rules, wherein instructions to determine which artifacts are safe to rename comprises instructions executable by the processor to cause the apparatus to,
determine as unsafe to rename an artifact name in the metadata section if in the first set of artifact names as a string or substring; and
evaluate the artifact name detected in the metadata section against the set of heuristics-based rules; and
rename each artifact name determined to be safe to rename.

18. The apparatus of claim 17, wherein instructions to rename comprise instructions executable by the processor to cause the apparatus to invoke a pseudo-random word generator and rename based on output of the pseudo-random word generator.

19. The apparatus of claim 17, further comprising instructions executable by the processor to cause the apparatus to parse the executable file to locate the metadata sections.

20. The apparatus of claim 17, wherein the machine-readable medium further has stored thereon instructions executable by the processor to cause the apparatus to maintain a mapping of original artifact names to new artifact names, wherein instructions to rename comprise instructions executable by the processor to cause the apparatus to search the executable file for subsequent occurrences of an original artifact name and replace the original artifact names with a mapped new artifact name.
